(19) United States
(12) Patent Application Publication
(10) Pub. No.: US 2026/0260367 A1
(43) Pub. Date: Sep. 3, 2026

(54) DEPTH MAP OPTIMIZATION MODEL TRAINING METHOD, APPARATUS, DEVICE AND STORAGE MEDIUM

(71) Applicant: BOE Technology Group Co., Ltd., Beijing (CN)

(72) Inventor: Xuan SUN, Beijing (CN)

(21) Appl. No.: 18/995,792

(22) PCT Filed: Aug. 28, 2023
(86) PCT No.: PCT/CN2023/115287

§ 371 Date: Jan. 16, 2025

(51) Int. Cl. G06T 7/55; G06T 7/11; G06T 7/194; G06T 15/20

(52) U.S. Cl. CPC G06T 7/55; G06T 7/11; G06T 7/194; G06T 15/205; G06T 2200/04; G06T 2207/10016; G06T 2207/20081; G06T 2207/20084

(57) ABSTRACT

A depth map optimization model training method is provided, including: acquiring a depth map optimization model and a viewpoint rendering model; acquiring a training sample set; where sample features of any one training sample in the training sample set includes a first viewpoint map and a first depth map, and a sample label of the any one training sample includes a second viewpoint map; the depth map optimization model is configured to, according to an input first viewpoint map and an input first depth map, optimize the input first depth map to obtain an optimized depth map; the viewpoint rendering model predicts a corresponding second viewpoint map according to the input first viewpoint map and the optimized depth map obtained by the depth map optimization model to obtain a prediction viewpoint map; and training the depth map optimization model and the viewpoint rendering model based on the training sample set.

### TECHNICAL FIELD

The present disclosure relates to the field of image processing technologies, and in particular to, depth map optimization model training methods, apparatuses, devices and storage media.

### BACKGROUND

In current image processing businesses, many businesses need to utilize depth maps. For example, a depth map may be used when generating a stereoscopic three-dimensional visual image, and a depth map may be used to assist in rendering when performing image rendering processing, which may specifically be to highlight foreground regions.

However, a current depth map is often determined based on a single viewpoint image according to an algorithm (e.g., a monocular depth estimation algorithm). The depth map determined in this way has low estimation accuracy for depth information.

### SUMMARY

The present disclosure provides depth map optimization model training methods, apparatuses, devices and storage media, so as to solve deficiencies in related arts.

According to a first aspect of an embodiment of the present disclosure, a depth map optimization model training method is provided, including:
acquiring a depth map optimization model and a viewpoint rendering model;
acquiring a training sample set; where sample features of any one training sample in the training sample set includes a first viewpoint map and a first depth map, and a sample label of the any one training sample includes a second viewpoint map corresponding to the first viewpoint map;
the first depth map includes depth information of each pixel in the first viewpoint map, and the first viewpoint map and the second viewpoint map represent a same image at different viewpoints;
the depth map optimization model is configured to, according to an input first viewpoint map and an input first depth map, optimize the input first depth map to obtain an optimized depth map;
the viewpoint rendering model is configured to predict a corresponding second viewpoint map according to the input first viewpoint map and the optimized depth map obtained by the depth map optimization model to obtain a prediction viewpoint map;
training the depth map optimization model and the viewpoint rendering model based on the training sample set;
during the training, updating parameters of the depth map optimization model according to a loss between the second viewpoint map and the prediction viewpoint map.

In some examples, the method further includes determining a foreground region for the first viewpoint map;
where updating the parameters of the depth map optimization model according to the loss between the second viewpoint map and the prediction viewpoint map includes:
updating the parameters of the depth map optimization model according to a loss between the second viewpoint map and the prediction viewpoint map in a same target region;
where a position of the target region in the second viewpoint map and the prediction viewpoint map is the same as a position of the determined foreground region in the first viewpoint map.

In some examples, where determining the foreground region for the first viewpoint map includes any of:
performing foreground target detection on the first viewpoint map to determine the foreground region;
performing foreground target detection on the first viewpoint map to obtain a foreground region box, performing target segmentation on an image content in the foreground region box, and determining a segmented image content as the foreground region; or performing foreground target segmentation on the first viewpoint map, and
determining a segmented image content as the foreground region.

In some examples, the depth map optimization model includes a viewpoint map feature extraction layer and a depth map feature extraction layer;
where the viewpoint map feature extraction layer is configured to extract a first viewpoint feature map from the input first viewpoint map, and obtain a second viewpoint feature map by raising a dimensionality of the obtained first viewpoint feature map; and
the depth map feature extraction layer is configured to extract a first depth feature map from the input first depth map, and obtain a second depth feature map by raising a dimensionality of the obtained first depth feature map.

In some examples, the depth map optimization model includes a feature fusion layer;
where the depth map optimization model is configured to obtain a synthesized feature map by synthesizing a viewpoint feature map extracted from the first viewpoint map and a depth feature map extracted from the first depth map;
the feature fusion layer is configured to obtain a dimension-reduction feature map by reducing a dimensionality of an input feature map, obtain a fused feature map by performing feature fusion on the dimension-reduction feature map. obtain a dimension-raising feature map by raising a dimensionality of the fused feature map, and output a sum of the dimension-raising feature map and the input feature map;
the input feature map includes any one of: the synthesized feature map, a feature map extracted from the synthesized feature map, or a feature map output by other feature fusion layer.

In some examples, the first viewpoint map, the first viewpoint map, the first depth map and the second viewpoint map are acquired based on a same three-dimensional image.

In some examples, any one training sample in the training sample set is acquired by:
acquiring a target three-dimensional image;
acquiring images of the target three-dimensional image at two different viewpoints, and taking the images respectively as the first viewpoint map and the second viewpoint map corresponding to the first viewpoint map;
determining the first depth map by acquiring the depth information of each pixel in the first viewpoint map based on depth information of the target three-dimensional image; or, determining the first depth map from the first viewpoint map with a preset depth estimation algorithm; and
obtaining a training sample by taking the determined first viewpoint map and the determined first depth map as the sample features and taking the determined second viewpoint map as the sample label.

In some examples, the viewpoint rendering model is pre-trained; the method further includes: freezing parameters of the viewpoint rendering model while training the depth map optimization model and the viewpoint rendering model.

In some examples, the method further includes:
during the training, updating parameters of the viewpoint rendering model based on the loss between the second viewpoint map and the prediction viewpoint map.

In some examples, the viewpoint rendering model includes a first dimension-raising fusion layer;
the viewpoint rendering model is configured to extract a third viewpoint feature map with a first size and a fourth viewpoint feature map with a second size from the first viewpoint map, where the first size is smaller than the second size, and obtain an optimized fusion feature map with the first size by performing feature fusion on the third viewpoint feature map and an optimized feature map extracted from the optimized depth map; and
the first dimension-raising fusion layer is configured to obtain a dimension-raising fusion feature map with the second size by raising a dimensionality of the optimized fusion feature map, perform feature fusion on the dimension-raising fusion feature map and the fourth viewpoint feature map, and output a fusion result of the second size.

In some examples, the viewpoint rendering model further includes a second dimension-raising fusion layer;
the viewpoint rendering model is configured to extract a fifth viewpoint feature map with a third size from the first viewpoint map; where the second size is smaller than the third size; and
the second dimension-raising fusion layer is configured to obtain a to-be-fused feature map with the third size by raising a dimensionality of the fusion result output by the first dimension-raising fusion layer, perform feature fusion on the to-be-fused feature map and the fifth viewpoint feature map, and output a fusion result of the third size.

According to a second aspect of an embodiment of the present disclosure, a depth map optimization model training apparatus is provided, including:
an acquisition unit, configured to acquire a depth map optimization model and a viewpoint rendering model, and acquire a training sample set; where sample features of any one training sample in the training sample set includes a first viewpoint map and a first depth map, and a sample label of the any one training sample includes a second viewpoint map corresponding to the first viewpoint map;
the first depth map includes depth information of each pixel in the first viewpoint map, and the first viewpoint map and the second viewpoint map represent a same image at different viewpoints;
the depth map optimization model is configured to, according to an input first viewpoint map and an input first depth map, optimize the input first depth map to obtain an optimized depth map;
the viewpoint rendering model is configured to predict a corresponding second viewpoint map according to the input first viewpoint map and the optimized depth map obtained by the depth map optimization model to obtain a prediction viewpoint map;
a training unit, configured to train the depth map optimization model and the viewpoint rendering model based on the training sample set; and
during the training, update parameters of the depth map optimization model according to a loss between the second viewpoint map and the prediction viewpoint map.

In some examples, the training unit is further configured to determine a foreground region for the first viewpoint map;
the training unit is configured to:
update the parameters of the depth map optimization model according to a loss between the second viewpoint map and the prediction viewpoint map in a same target region;
where a position of the target region in the second viewpoint map and the prediction viewpoint map is the same as a position of the determined foreground region in the first viewpoint map.

In some examples, the training unit is further configured perform any of the following to determine the foreground region for the first viewpoint map:
perform foreground target detection on the first viewpoint map to determine the foreground region;
perform foreground target detection on the first viewpoint map to obtain a foreground region box, perform target segmentation on an image content in the foreground region box, and determine a segmented image content as the foreground region; or
perform foreground target segmentation on the first viewpoint map, and determining a segmented image content as the foreground region.

In some examples, the depth map optimization model includes a viewpoint map feature extraction layer and a depth map feature extraction layer;
where the viewpoint map feature extraction layer is configured to extract a first viewpoint feature map from the input first viewpoint map, and obtain a second viewpoint feature map by raising a dimensionality of the obtained first viewpoint feature map; and
the depth map feature extraction layer is configured to extract a first depth feature map from the input first depth map, and obtain a second depth feature map by raising a dimensionality of the obtained first depth feature map.

In some examples, the depth map optimization model includes a feature fusion layer;
where the depth map optimization model is configured to obtain a synthesized feature map by synthesizing a viewpoint feature map extracted from the first viewpoint map and a depth feature map extracted from the first depth map;
the feature fusion layer is configured to obtain a dimension-reduction feature map by reducing a dimensionality of an input feature map, obtain a fused feature map by performing feature fusion on the dimension-reduction feature map, obtain a dimension-raising feature map by raising a dimensionality of the fused feature map, and output a sum of the dimension-raising feature map and the input feature map;
the input feature map includes any one of: the synthesized feature map, a feature map extracted from the synthesized feature map, or a feature map output by other feature fusion layer.

In some examples, the first viewpoint map, the first viewpoint map, the first depth map and the second viewpoint map are acquired based on a same three-dimensional image.

In some examples, any one training sample in the training sample set includes is acquired by:
acquiring a target three-dimensional image;
acquiring images of the target three-dimensional image at two different viewpoints, and taking the images respectively as the first viewpoint map and the second viewpoint map corresponding to the first viewpoint map;
determining the first depth map by acquiring the depth information of each pixel in the first viewpoint map based on depth information of the target three-dimensional image; or,
determining the first depth map from the first viewpoint map with a preset depth estimation algorithm; and
obtaining a training sample by taking the determined first viewpoint map and the determined first depth map as the sample features and taking the determined second viewpoint map as the sample label.

In some examples, the viewpoint rendering model is pre-trained; and the training unit is further configured to freeze parameters of the viewpoint rendering model while training the depth map optimization model and the viewpoint rendering model.

In some examples, the training unit is further configured to:
during the training, update parameters of the viewpoint rendering model based on the loss between the second viewpoint map and the prediction viewpoint map.

In some examples, the viewpoint rendering model includes a first dimension-raising fusion layer;
the viewpoint rendering model is configured to extract a third viewpoint feature map with a first size and a fourth viewpoint feature map with a second size from the first viewpoint map, where the first size is smaller than the second size, and obtain an optimized fusion feature map with the first size by performing feature fusion on the third viewpoint feature map and an optimized feature map extracted from the optimized depth map; and
the first dimension-raising fusion layer is configured to obtain a dimension-raising fusion feature map with the second size by raising a dimensionality of the optimized fusion feature map, perform feature fusion on the dimension-raising fusion feature map and the fourth viewpoint feature map, and output a fusion result of the second size.

In some examples, the viewpoint rendering model further includes a second dimension-raising fusion layer;
the viewpoint rendering model is configured to extract a fifth viewpoint feature map with a third size from the first viewpoint map; where the second size is smaller than the third size; and
the second dimension-raising fusion layer is configured to obtain a to-be-fused feature map with the third size by raising a dimensionality of the fusion result output by the first dimension-raising fusion layer, perform feature fusion on the to-be-fused feature map and the fifth viewpoint feature map, and output a fusion result of the third size.

According to the above embodiments, by training the depth map optimization model with the same image from different viewpoints, it is convenient for the depth map optimization model to learn and mine more accurate depth information from different viewpoints during the training process, thus facilitating the improvement of the accuracy of depth information in the depth map.

It should be understood that the above general description and the following detailed descriptions are exemplary and explanatory only and do not limit the present disclosure.

### BRIEF DESCRIPTION OF DRAWINGS

The accompanying drawings, which are incorporated in and constitute a part of the specification, illustrate embodiments consistent with the present disclosure, and are used together with the specification to explain the principles of the present disclosure.

FIG. 1 is a flowchart of a depth map optimization model training method according to an embodiment of the present disclosure;

FIG. 2 is a schematic structural diagram of a depth map optimization model according to an embodiment of the present disclosure;

FIG. 3 is a schematic structural diagram of a viewpoint rendering model according to an embodiment of the present disclosure;

FIG. 4 is a flowchart of a depth map optimization method according to an embodiment of the present disclosure;

FIG. 5 is a flowchart of a three-dimensional image generation method according to an embodiment of the present disclosure;

FIG. 6 is a flowchart of a three-dimensional video conversion method according to an embodiment of the present disclosure;

FIG. 7 is a principle diagram of a depth map optimization model training according to an embodiment of the present disclosure;

FIG. 8 is a schematic diagram of an image optimization result according to an embodiment of the present disclosure;

FIG. 9 is a schematic structural diagram of a depth map optimization model training apparatus according to an embodiment of the present disclosure;

FIG. 10 is a schematic structural diagram of a depth map optimization apparatus according to an embodiment of the present disclosure;

FIG. 11 is a schematic structural diagram of a three-dimensional image generation apparatus according to an embodiment of the present disclosure;

FIG. 12 is a schematic structural diagram of a three-dimensional video conversion apparatus according to an embodiment of the present disclosure; and

FIG. 13 is a schematic diagram of a hardware structure of a computer device for configuring the method according to an embodiment of the present disclosure.

### DETAILED DESCRIPTION

Reference will now be made in detail to exemplary embodiments, examples of which are illustrated in the accompanying drawings. When the following description refers to the accompanying drawings, unless otherwise indicated, the same numbers in different accompanying drawings indicate the same or similar elements. Implementations described in the following exemplary embodiments do not represent all implementations consistent with the present disclosure. Rather, they are merely examples of apparatuses and methods consistent with some aspects of the present disclosure as detailed in the appended claims.

It should be noted that user information (including but not limited to user equipment information, user personal information, etc.) and data (including but not limited to data for analysis, data for storage, data for presentation, etc.) involved in embodiments of the present disclosure are all information and data authorized by users or fully authorized by all parties, and collection, use and processing of relevant data need to comply with relevant laws, regulations and standards of relevant countries and regions, and corresponding operation portals are provided for users to choose authorization or rejection.

In current image processing businesses, many businesses need to utilize depth maps. For example, a depth map may be used when generating a stereoscopic three-dimensional visual image, and a depth map may be used to assist in rendering when performing image rendering processing, which may specifically be to highlight foreground regions.

However, a current depth map is often determined based on a single viewpoint image according to an algorithm (e.g., a monocular depth estimation algorithm). The depth map determined in this way has low estimation accuracy for depth information.

In order to solve the above problems, an embodiment of the present disclosure discloses a depth map optimization model training method.

In this method, machine learning is introduced to train a depth map optimization model, which is convenient to optimize a depth map by using a trained depth map optimization model and improve an accuracy of depth information in a depth map.

In order to improve the accuracy of depth information in the depth map, this method further introduces same image from different viewpoints. Because the same image from different viewpoints can be used to determine a three-dimensional image, it is convenient to learn and mine more accurate depth information.

The same image at different viewpoints may be, e.g., a left viewpoint map and a right viewpoint map of a same scene, or two images obtained by a binocular camera at the same time.

Based on the same image from these different viewpoints, it is convenient to mine information of three-dimensional scenes, thus facilitating mining of more accurate depth information.

For the introduction of images from different viewpoints, in order to achieve model training, this method discloses a model structure for predicting the same image from another viewpoint based on an image and a depth map from one viewpoint. Through this prediction between the same image from different viewpoints, it is convenient to learn and mine more accurate depth information.

A specific model structure can be designed into a two-stage model structure by dividing tasks, which can include a depth map optimization model and a viewpoint rendering model.

The depth map optimization model can be used to further optimize the depth map based on the map and depth map at one viewpoint, while the viewpoint rendering model can predict the same image at another viewpoint based on the optimized depth map and the map at one viewpoint.

By training based on the above model structure, depth information of the same image from different viewpoints can be mined through the depth map optimization model learning, so as to improve the accuracy of depth information.

Moreover, it is convenient to check an effect of model training by the two-stage model structure divided by the task.

Moreover, this model structure can realize unsupervised training of the depth map optimization model, and it is not necessary to obtain a sample label of an optimized depth map, and the model can be trained by using the same image from different viewpoints, which subtly reduces the difficulty of obtaining training samples.

The trained depth map optimization model can be used to optimize the depth map and improve the accuracy of depth information in the depth map.

A depth map optimization model training method provided by an embodiment of the present disclosure will be explained in detail below.

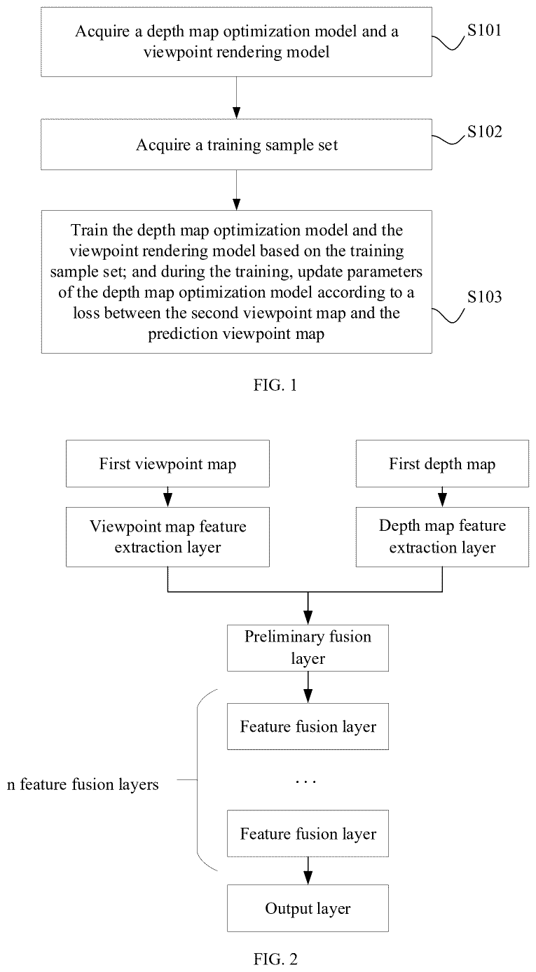

As shown in FIG. 1, FIG. 1 is a flowchart of a depth map optimization model training method according to an embodiment of the present disclosure.

The embodiment of the present disclosure does not limit an execution subject of the method flow. In some examples, the execution subject may be any computing device. For example, a server or a client for optimizing a depth map, or a server or a client for providing an image processing function.

The method may include the following steps.

At S101, a depth map optimization model and a viewpoint rendering model are acquired.

At S102, a training sample set is acquired.

Sample features of any one training sample in the training sample set may include a first viewpoint map and a first depth map, and a sample label of the any one training sample may include a second viewpoint map corresponding to the first viewpoint map.

The first depth map may include depth information of each pixel in the first viewpoint map, and the first viewpoint map and the second viewpoint map corresponding to the first viewpoint map can represent a same image at different viewpoints.

The depth map optimization model may be used to, according to an input first viewpoint map and an input first depth map, optimize the input first depth map to obtain an optimized depth map.

The viewpoint rendering model may be used to predict a corresponding second viewpoint map according to the input first viewpoint map and the optimized depth map obtained by the depth map optimization model to obtain a prediction viewpoint map.

At S103, the depth map optimization model and the viewpoint rendering model are trained based on the training sample set, and during the training, parameters of the depth map optimization model are updated according to a loss between the second viewpoint map and the prediction viewpoint map.

According to the above method flow, by training the depth map optimization model with the same image from different viewpoints, it is convenient for the depth map optimization model to learn and mine more accurate depth information from different viewpoints during the training process, thus facilitating the improvement of the accuracy of depth information in the depth map.

In addition, the above method flow can further realize unsupervised training of the depth map optimization model, and it is not necessary to obtain a sample label of an optimized depth map, and the model can be trained by using the same image from different viewpoints, which subtly reduces the difficulty of obtaining training samples.

Detailed explanations for each aspect are provided below.

### I. About the Training Sample Set

Sample features of any one training sample in the training sample set may include a first viewpoint map and a first depth map, and a sample label of the any one training sample may include a second viewpoint map corresponding to the first viewpoint map.

In order to facilitate understanding, firstly, the first viewpoint map, the first depth map and the second viewpoint map in the any one training sample in the training sample set are explained.

In some examples, the first viewpoint map may be a single viewpoint image, and the first depth map may contain the depth information of each pixel under the viewpoint where the first viewpoint map is located.

In some examples, the first viewpoint map and the second viewpoint map corresponding to the first viewpoint map may represent a same image at different viewpoints. Specifically, they can represent a same three-dimensional image from different viewpoints.

For example, for the same three-dimensional image, a left viewpoint map can be determined as the first viewpoint map and a right viewpoint map can be determined as the corresponding second viewpoint map.

For another example, for the same scene, a captured left viewpoint map can be determined as the first viewpoint map and a captured right viewpoint map can be determined as the corresponding second viewpoint map. Or, for the same scene, a captured right viewpoint map can be determined as the first viewpoint map and a captured left viewpoint map can be determined as the corresponding second viewpoint map.

In some examples, the second viewpoint map can be used to construct a three-dimensional image with a corresponding first viewpoint map.

In some examples, the first viewpoint map and the corresponding second viewpoint map may be different images of the same scene taken at the same time at different viewpoints.

In some examples, the first viewpoint map and the corresponding second viewpoint map may be two different images captured simultaneously by a binocular camera. The first viewpoint map and the corresponding second viewpoint map can also be two different images captured simultaneously by a multi-camera.

The features and label in a single training sample have been explained above, and it can be understood that other training samples in the training sample set can refer to the above explanation.

In some examples, sample features of each training sample in the training sample set contains a first viewpoint map and a first depth map, and a sample label of that training sample contains a second viewpoint map corresponding to that first viewpoint map.

Within each training sample, the first viewpoint map in the sample feature and the second viewpoint map in the sample label may both be the same image at different viewpoints.

The first viewpoint map between different training samples can be different images, and the second viewpoint map between different training samples can also be different images.

The flow of this method does not limit a source of the training sample set.

In some examples, the first viewpoint map, the first depth map and the corresponding second viewpoint map may be directly obtained and combined into a training sample.

In some examples, the first viewpoint map, the first depth map and the corresponding second viewpoint map may be generated based on the image, so as to be combined into a training sample.

In some examples, the first viewpoint map, the first depth map and the second viewpoint map may be acquired based on a same three-dimensional image.

For the same three-dimensional image, different single viewpoint maps at different viewpoints can be conveniently extracted, which improves the convenience of sample acquisition. The first depth map can be determined based on depth information in the same three-dimensional image, specifically according to the depth information of each pixel in a single viewpoint image at a viewpoint corresponding to the first viewpoint map.

According to this embodiment, the convenience of sample acquisition can be improved based on the same three-dimensional image.

The flow of this method is not limited to a way of obtaining samples based on three-dimensional images.

For the convenience of understanding, in some examples, any one training sample in the training sample set may be acquired by: acquiring a target three-dimensional image; acquiring images of the target three-dimensional image at two different viewpoints, and taking the images respectively as the first viewpoint map and the second viewpoint map corresponding to the first viewpoint map; determining the first depth map by acquiring the depth information of each pixel in the first viewpoint map based on depth information of the target three-dimensional image; and obtaining a training sample by taking the determined first viewpoint map and the determined first depth map as the sample features and taking the determined second viewpoint map as the sample label.

In some examples, any one training sample in the training sample set may be acquired by: acquiring a target three-dimensional image; acquiring images of the target three-dimensional image at two different viewpoints, and taking the images respectively as the first viewpoint map and the second viewpoint map corresponding to the first viewpoint map; determining the first depth map from the first viewpoint map with a preset depth estimation algorithm; and obtaining a training sample by taking the determined first viewpoint map and the determined first depth map as the sample features and taking the determined second viewpoint map as the sample label.

In some examples, the preset depth estimation algorithm may be a monocular depth estimation algorithm.

A specific way to acquire samples based on a three-dimensional image is clearly disclosed in this embodiment, which can improve the efficiency of sample acquisition.

### II. About the Depth Map Optimization Model

The depth map optimization model may be used to, according to an input first viewpoint map and an input first depth map, optimize the input first depth map to obtain an optimized depth map.

The flow of this method does not limit a specific structure of the depth map optimization model.

In some examples, the depth map optimization model can adopt a graph neural network, a graph convolution network and other structures.

### 1. About Feature Extraction

In some examples, for the input first viewpoint map and the input first depth map, a feature map can be extracted for subsequent optimization of the depth map.

In some examples, the depth map optimization model can include a viewpoint map feature extraction layer.

In some examples, the viewpoint map feature extraction layer can be used to extract a first viewpoint feature map from an input first viewpoint map, and obtain a second viewpoint feature map by raising a dimensionality of the obtained first viewpoint feature map.

A way of extracting the first viewpoint feature map is not limited in the embodiment, and in some examples, the feature map can be extracted from a graph convolution or graph neural.

A way to increase the dimensionality is not limited in the embodiment, in some examples, at least one of the following can be increased: channel dimension, resolution dimension, width and height, and so on.

In some examples, the depth map optimization model can include a depth map feature extraction layer.

In some examples, the depth map feature extraction layer can be used to extract a first depth feature map from the input first depth map, and obtain a second depth feature map by raising a dimensionality of the obtained first depth feature map.

A way of extracting the first depth feature map is not limited in the embodiment, and in some examples, the feature map can be extracted from a graph convolution or graph neural.

A way to increase the dimensionality is not limited in the embodiment, in some examples, at least one of the following can be increased: channel dimension, resolution dimension, width and height, and so on. Specifically, it can be improved for the channel dimension.

In this embodiment, features can be extracted first, and then the dimensionality of the feature map can be increased, so that low-dimensional features can be extracted during feature extraction under the condition that the dimensionality of the feature map is high (high precision), the calculation amount is reduced, and the calculation efficiency is improved.

For the convenience of understanding, an example of the viewpoint map feature extraction layer or the depth map feature extraction layer is given below.

Firstly, a one-layer two-dimensional graph convolution neural network is configured to preliminarily extract features of the input first viewpoint map (with a size of 3×H×W, where His a height of the first viewpoint map, W is a width of the first viewpoint map, and 3 is three channels of RGB), and an obtained feature size is B×(C/2)×H×W (where B is a batch size and C is the number of channels to be processed).

Then, the features extracted from a previous layer are fused by using the one-layer two-dimensional graph convolution neural network, and an obtained feature size is B×(C/2)×H×W.

Finally, the one-layer two-dimensional graph convolution neural network is configured to raise channel dimension of the features extracted from the previous layer, and a final feature size is B×C×H×W.

The whole feature extraction layer is funnel-shaped in the channel dimension, and the design can achieve a good balance between computation and performance.

### 2. About Feature Fusion

In some examples, the depth map optimization model needs to output an optimized first depth map for the input first viewpoint map and the input first depth map, so it is necessary to fuse feature maps.

In some examples, the depth map optimization model can be used to fuse the first viewpoint feature map and the first depth feature map, or can also be used to fuse the second viewpoint feature map and the second depth feature map.

In some examples, the depth map optimization model may include a feature fusion layer.

In some examples, the depth map optimization model may be used to obtain a synthesized feature map by synthesizing a viewpoint feature map extracted from the first viewpoint map and a depth feature map extracted from the first depth map.

The way to extract the viewpoint feature map is not limited, and the way to extract the depth feature map is not limited. The first viewpoint feature map or the second viewpoint feature map may be extracted, or the first depth feature map or the second depth feature map may be extracted.

The specific synthesis method is not limited. It may be to perform feature fusion to obtain a synthesized feature map, or it may be to further extract features based on a fusion result after feature fusion. For example, according to the fusion result, the synthesized feature map is extracted by using a graph convolution.

In some examples, the feature fusion layer can be used to obtain a dimension-reduction feature map by reducing a dimensionality of an input feature map, obtain a fused feature map by performing feature fusion on the dimension-reduction feature map, obtain a dimension-raising feature map by raising a dimensionality of the fused feature map, and output the dimension-raising feature map.

In some examples, the feature fusion layer can be used to obtain a dimension-reduction feature map by reducing a dimensionality of an input feature map, obtain a fused feature map by performing feature fusion on the dimension-reduction feature map, obtain a dimension-raising feature map by raising a dimensionality of the fused feature map, and output a sum of the dimension-raising feature map and the input feature map.

In some examples, the input feature map may include any one of: the synthesized feature map, a feature map extracted from the synthesized feature map, or a feature map output by other feature fusion layer.

The feature fusion layer can fuse the low-dimensional features by reducing the dimensionality, reducing the calculation amount, and then raising the dimensionality of the fused feature map, so that low-dimensional features can be extracted during feature extraction under the condition that the dimensionality of the feature map is high (high precision), the calculation amount is reduced, and the calculation efficiency is improved.

Moreover, by introducing a residual structure, a sum of the dimension-raising feature map and the input feature map can be output, and a learning fitting ability and model training effect of the feature fusion layer can be improved.

In addition, the depth map optimization model can include one or more feature fusion layers, which can be further fused directly for the synthesized feature map, or the features can be extracted from the synthesized feature map before further fusion, or outputs of other feature fusion layers can be further fused.

Each feature fusion layer can be in a series structure.

A way of extracting the feature map for the synthesized feature map is not limited in the embodiment, and in some examples, the feature map can be extracted from a graph convolution or graph neural.

A way to reduce or raise the dimensionality is not limited in the embodiment, in some examples, at least one of the following can be reduced or increased: channel dimension, resolution dimension, width and height, and so on. Specifically, it can reduce and increase the channel dimension.

For the convenience of understanding, an example of a feature fusion layer is given below.

Firstly, a one-layer two-dimensional graph convolution neural network is configured to reduce the dimensionality of the input feature (with a size of B×C×H×W), and an obtained feature size is B×(C/2)×H×W.

Then, the one-layer two-dimensional graph convolution neural network is configured to fuse the reduced-dimension feature, and an obtained feature size is B×(C/2)×H×W.

Finally, the one-layer two-dimensional graph convolution neural network is configured to raise channel dimension of the fusion feature, and a final feature size is B×C×H×W.

A residual connection is added to the feature fusion layer, which is beneficial to the optimization and convergence of the network. The design can achieve a good balance between computation and performance.

### 3. About Output

In some examples, the depth map optimization model may further include an output layer, which is configured to output a prediction optimized depth map according to a feature map output by a previous layer. Specifically, the prediction optimized depth map can be output according to a feature map output by a previous feature fusion layer.

A structure of the output layer is not limited in the embodiment, and may be a graph convolution network or a graph neural network.

To facilitate understanding, an example of an output layer is given below.

Firstly, a one-layer two-dimensional graph convolution neural network is configured to preliminarily reduce the dimensionality of the input feature (with a size of B×C×H×W), and an obtained feature size is B×(C/2)×H×W.

Then, the one-layer two-dimensional graph convolution neural network is configured to reduce the dimensionality of the channel again, and an obtained feature size is B×(C/4)×H×W.

Finally, the features are reconstructed using the one-layer two-dimensional graph convolution neural network, and a final output image is of size B×3×H×W.

The output layer gradually reduces the channel dimension through a three-layer two-dimensional graph convolution to output a final color three-channel image.

### 4. Example of Depth Map Optimization Model Structure

As shown in FIG. 2, FIG. 2 is a schematic structural diagram of a depth map optimization model according to an embodiment of the present disclosure.

The depth map optimization model can include a viewpoint map feature extraction layer, a depth map feature extraction layer, a preliminary fusion layer, n feature fusion layers and an output layer.

Steps for processing an image through the model are explained below.
(1) First, a first viewpoint map (with a size of 3×H×W, where H is a height of the image, W is a width of the image, and 3 is three channels of RGB) and its corresponding first depth map (with a size of 3×H×W, where H is the height of the image, W is the width of the image, and 3 is the three channels of RGB) are taken as inputs of the depth map optimization model. Input B first viewpoint maps into the viewpoint map feature extraction layer for feature extraction to obtain a second viewpoint feature map (with a size of B×C×H×W), and input B first depth maps into the depth map feature extraction layer for feature extraction to obtain a second depth feature map (with a size of B×C×H×W) (where B is a batch size and C is the number of channels processed).
(2) Then, the two features are spliced in the channel dimension, and a spliced feature with a size of B×(2C)×H×W is obtained. Through a preliminary fusion layer, dimension of the channel is reduced by twice, and an initial fusion of the two features is realized, and a synthesized feature map (with a size of B×C×H×W) is obtained.
(3) Secondly, the synthesized feature map is input into n feature fusion layers for further feature fusion, and a fused feature map (with a size of B×C×H×W) is obtained. The purpose is to use edge information in the first viewpoint map to guide an optimization of the first depth map and improve an accuracy of depth information in a depth map.
(4) Finally, the fused feature map is input to the output layer for fusion and dimension-reduction of the channel, and finally B optimized depth maps (with sizes of 3×H×W) are obtained.

### III. About the Viewpoint Rendering Model

The viewpoint rendering model may be used to predict a corresponding second viewpoint map according to the first viewpoint map and the optimized depth map obtained by the depth map optimization model to obtain a prediction viewpoint map. Specifically, the second viewpoint map corresponding to the input first viewpoint map can be used as a prediction target, and prediction can be performed to obtain the prediction viewpoint map. And the second viewpoint map corresponding to the first viewpoint map is a label of the training sample.

The flow of this method does not limit a specific structure of the viewpoint rendering model.

In some examples, the viewpoint rendering model can adopt a graph neural network, a graph convolution network and other structures.

In an optional embodiment, the viewpoint rendering model can perform feature fusion for the input optimized depth map and the first viewpoint map.

In some examples, the viewpoint rendering model can be used to perform feature fusion on the input optimized depth map and the first viewpoint map, and predict the second viewpoint map corresponding to the input first viewpoint map based on a fusion result to obtain the prediction viewpoint map.

In some examples, in order to reduce calculation amount, dimensions of the feature map extracted from the optimized depth map and the first viewpoint map can be reduced, feature fusion can be performed on the reduced-dimension feature map, and then a dimension can be increased according to the fusion result.

Further, in some examples, a plurality of viewpoint feature maps with different dimensions can be extracted from the first viewpoint map, and in the process of dimension-raising, the extracted viewpoint feature maps with different dimensions are combined for fusion and feature extraction, so that an accuracy of predicting the corresponding second viewpoint map (i.e. an accuracy of prediction viewpoint map) can be conveniently improved by using the viewpoint feature maps of the first viewpoint map.

In some examples, a plurality of viewpoint feature maps with different dimensions can be extracted from the optimized depth map, and in the process of dimension-raising, the extracted depth feature maps with different dimensions are combined for fusion and feature extraction, so that an accuracy of predicting the corresponding second viewpoint map (i.e. an accuracy of prediction viewpoint map) can be conveniently improved by using the depth feature maps of the optimized depth map.

The above two embodiments can be combined with each other, and the viewpoint feature map and depth feature map with different dimensions can be combined in the process of dimension-raising.

In order to facilitate understanding, in a specific example, viewpoint feature maps with resolutions of 8×8, 4×4 and 2×2 can be extracted from the first viewpoint map, and depth feature maps with resolutions of 8×8, 4×4 and 2×2 can be extracted from the optimized depth map. After that, feature fusion can be performed on the viewpoint feature map with a resolution of 2×2 and the depth feature map with a resolution of 2×2, the dimension of a fusion result with a resolution of 2×2 is raised to obtain a 4×4 fusion result, and then a fusion result is obtained by combining the 4×4 viewpoint feature map and/or the 4×4 depth feature map for fusion. After that, the dimension of a dimension-raising fusion result with the 4×4 is raised to obtain an 8×8 dimension-raising fusion result, and then a final result feature map is obtained by combining the 8×8 viewpoint feature map and/or 8×8 depth feature map for fusion. The result feature map can be used to reconstruct and generate the prediction viewpoint map.

In some examples, the viewpoint rendering model is configured to extract a third viewpoint feature map with a first size and a fourth viewpoint feature map with a second size from the first viewpoint map, where the first size is smaller than the second size, and obtain an optimized fusion feature map with the first size by performing feature fusion on the third viewpoint feature map and an optimized feature map extracted from the optimized depth map.

In some examples, the viewpoint rendering model may include a first dimension-raising fusion layer.

In some examples, the first dimension-raising fusion layer can be used to obtain a dimension-raising fusion feature map with the second size by raising a dimensionality of the optimized fusion feature map, perform feature fusion on the dimension-raising fusion feature map and the fourth viewpoint feature map, and output a fusion result of the second size.

A specific way of feature fusion is not limited in the embodiment, and feature fusion can be carried out by means of graph convolution, graph neural network, graph sampling, pooling, etc.

A size of the optimized feature map extracted from the optimized depth map may be the first size.

On the one hand, this embodiment can fuse the feature map with a lower size, then through dimensionality-raising fusion, while ensuring that the feature map has a higher dimension (high accuracy), low-dimensional features can be used for fusion during feature fusion, thereby reducing calculation amount and improving calculation efficiency.

On the other hand, by combining higher-dimensional viewpoint feature maps in the dimensionality-raising process, an accuracy of the prediction viewpoint map can be improved.

In addition, in some examples, the dimensionality of the feature map can also be directly increased without fusing a fourth viewpoint feature map. In some examples, the depth feature map of the second size can also be fused during the dimensionality-raising process.

In some examples, on the basis of the first dimension-raising fusion layer, one or more similar dimension-raising fusion layers can be additionally added to gradually fuse the viewpoint feature map and/or the depth feature map at higher dimensionality.

In some examples, the viewpoint rendering model may further include a second dimension-raising fusion layer.

In some examples, the viewpoint rendering model can be further used to extract extracting a fifth viewpoint feature map with a third size from the first viewpoint map; where the second size is smaller than the third size.

In some examples, the second dimension-raising fusion layer can be used to obtain a to-be-fused feature map with the third size by raising a dimensionality of the fusion result output by the first dimension-raising fusion layer, perform feature fusion on the to-be-fused feature map and the fifth viewpoint feature map, and output a fusion result of the third size.

In this embodiment, the accuracy of the prediction viewpoint map can be improved through further dimensionality-raising fusion.

In some examples, the dimensionality of the feature map can also be directly increased without fusing a fifth viewpoint feature map. In some examples, the depth feature map of the third size can also be fused during the dimensionality-raising process.

In some examples, based on this embodiment, one or more series-connected dimension-raising fusion layers can be deployed in the viewpoint rendering model through simple reasoning. Specifically, the viewpoint rendering model can include one or more series-connected dimension-raising fusion layers, and a higher-dimensional viewpoint feature map and/or depth feature map can be fused step by step to improve the accuracy of the prediction viewpoint map.

For feature maps of different dimensions extracted from the first viewpoint map or optimized depth map, the process of this method does not limit the specific extraction method. In some examples, feature maps of different dimensions may be extracted by down sampling or dimensionality reduction for the extracted feature maps.

For example, for a C×H×W feature map extracted from the first viewpoint map, the C×(H/2)×(W/2) feature map and the C×(H/4)×(W/4) feature map can be extracted by down sampling.

As for a specific dimensionality-raising method of the dimension-raising fusion layer, it can be to increase at least one of the following: channel dimension, resolution dimension, width and height, and so on. Specifically, it can be improved for the resolution dimension.

For ease of understanding, the present method process further provides an example structure of a viewpoint rendering model.

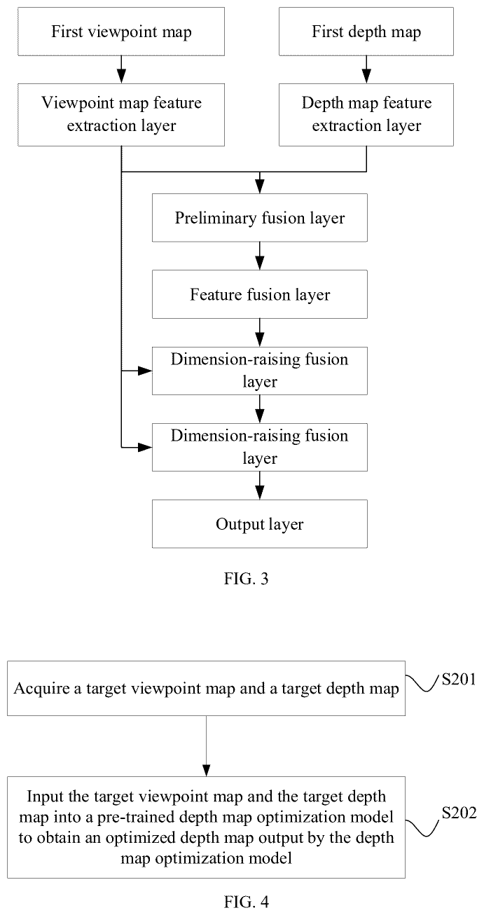

As shown in FIG. 3, FIG. 3 is a schematic structural diagram of a viewpoint rendering model according to an embodiment of the present disclosure.

The viewpoint rendering model can include a viewpoint map feature extraction layer, a depth map feature extraction layer, a preliminary fusion layer, a feature fusion layer, two dimension-raising fusion layers and an output layer. The number of dimension-raising fusion layers is used for exemplary illustration only, and specifically may also be three or more, etc.

Steps for processing a map through the model are explained below.
(1) Input a first viewpoint map (with a size of 3×H×W, where H is a height of the image, W is a width of the image, and 3 is three channels of RGB) to the viewpoint feature extraction layer.

Specifically, an initial feature extraction can be performed by one-layer convolution, then the H and W dimensions are down-sampled after 2 convolutions to obtain a feature map 1 with a size of B×C×H×W, a feature map 2 with a size of B×C×(H/2)×(W/2), and a feature map 3 With a Size of B×C×(H/4)×(W/4).
(2) Input an optimized depth map (with a size of 3×H×W, where H is a height of the image, W is a width of the image, and 3 is three channels of RGB) to the depth feature extraction layer.

Specifically, an initial feature extraction can be performed by one-layer convolution, then the H and W dimensions are down-sampled after 2 convolutions to obtain a feature map 4 with a size of B×C×(H/4)×(W/4).
(3) The feature map 3 and the feature map 4 are spliced in the channel dimension, and a feature map with a size of B×(2C)×(H/4)×(W/4) is obtained. After a preliminary fusion layer, specifically a two-dimensional convolutional neural network layer reduces the channel dimension by 2 times to achieve the preliminary fusion of the two features, and obtains feature map 5 (with a size of B×C×(H/4)×(W/4)).
(4) Input the feature map 5 into a feature fusion layer for feature fusion, and get a feature map 6 (with a size of B×C×(H/4)×(W/4)).
(5) Input the feature map 6 and the feature map 2 into one dimension-raising fusion layer.

Firstly, the dimension of feature map 6 is raised to B×C×(H/2)×(W/2), specifically, it can be raised by a Bilinear layer, then feature fusion is carried out, and then one layer of convolution is carried out to obtain a feature map 7 (with a size of B×C×(H/2)×(W/2)).
(6) Input the feature map 7 and the feature map 1 into one dimension-raising fusion layer.

Firstly, the dimension of feature map 7 is raised to B×C×H×W, specifically, it can be raised by the Bilinear layer, then feature fusion is carried out, and then one layer of convolution is carried out to obtain a feature map 8 (with a size of B×C×H×W).
(7) Finally, the feature map 8 is input to the output layer for fusion and channel dimension-reduction, and finally a prediction viewpoint map (with a size of 3×H×W) is obtained.

For the explanation of feature fusion and output layer, please refer to the explanation of depth map optimization model above.

### IV. About the Training Process

Regarding the depth map optimization model and viewpoint rendering model which are connected in series, this method flow does not limit a specific training method.

The depth map optimization model and the viewpoint rendering model can be trained based on the training sample set, and during the training, parameters of the depth map optimization model can be updated according to a loss between the second viewpoint map and the prediction viewpoint map.

In some examples, because the sample label in the training sample set is the second viewpoint map, the viewpoint rendering model needs to participate in the training, and the parameters of the viewpoint rendering model can be updated or not.

In some examples, the viewpoint rendering model is pre-trained; the method flow can further include freezing parameters of the viewpoint rendering model while training the depth map optimization model and the viewpoint rendering model.

According to this embodiment, the convergence speed and training efficiency can be improved by only updating the parameters of the depth map optimization model.

In some examples, the method flow may further include: during the training, updating parameters of the viewpoint rendering model based on the loss between the second viewpoint map and the prediction viewpoint map.

According to this embodiment, the depth map optimization model and the viewpoint rendering model can be updated through combined training, so as to improve the overall training effectiveness of both models.

As for the calculation method of loss, the flow of this method is not specifically limited.

In some examples, the loss may specifically be a similarity between the prediction viewpoint map and the second viewpoint map.

In some examples, model training and updating can be performed based on a total loss between a prediction viewpoint map and a second viewpoint map corresponding to each training sample. Specifically, L1 loss or L2 loss can be used for calculation.

In some examples, model training and updating can also be performed based on a loss between the prediction viewpoint map and the second viewpoint map of same partial region, and the loss can specifically be a similarity between image contents of the same region in the prediction viewpoint map and the second viewpoint map. Thereby highlighting key regions and improving training efficiency.

In some examples, for the depth map, depth information of a background may be uncertain, for example, it is generally difficult to accurately determine depth information for a background such as sky, city and horizon. For a foreground region, it is often the focus of viewing the image, and the depth information has better certainty.

Therefore, in some examples, the model can be trained and updated according to a loss between the prediction viewpoint map and the second viewpoint map of a same foreground region, thus highlighting the key region and improving the training efficiency.

In some examples, the method flow may further include: determining a foreground region for the first viewpoint map.

Updating the parameters of the depth map optimization model according to the loss between the second viewpoint map and the prediction viewpoint map may include: updating the parameters of the depth map optimization model according to a loss between the second viewpoint map and the prediction viewpoint map in a same target region; where a position of the target region in the second viewpoint map and the prediction viewpoint map is the same as a position of the determined foreground region in the first viewpoint map.

According to this embodiment, the loss of image content between the second viewpoint map and the prediction viewpoint map at a position in the foreground region can be determined by using the foreground region of the first viewpoint map, so that loss calculation efficiency can be improved.

In some examples, a foreground region may also be determined for the second viewpoint map, and updating the parameters of the depth map optimization model according to the loss between the second viewpoint map and the prediction viewpoint map may include: updating the parameters of the depth map optimization model according to a loss between the second viewpoint map and the prediction viewpoint map in a same target region; where a position of the target region in the second viewpoint map and the prediction viewpoint map is the same as a position of the determined foreground region in the second viewpoint map.

The flow of this method is not limited to a way of determining a foreground region.

In some examples, where determining the foreground region for the first viewpoint map may include any of the following:
(1) performing foreground target detection on the first viewpoint map to determine the foreground region;
(2) performing foreground target detection on the first viewpoint map to obtain a foreground region box, performing target segmentation on an image content in the foreground region box, and determining a segmented image content as the foreground region;
(3) performing foreground target segmentation on the first viewpoint map, and determining a segmented image content as the foreground region.

In this embodiment, the foreground region can be determined by means of target detection and target segmentation, and the efficiency and accuracy of determining the foreground region can be improved.

For ease of understanding, an example of a loss function is given below.

Firstly, according to a foreground region Fmask in the first viewpoint map, foreground portion of pixels corresponding to a generated prediction viewpoint map F2D-out are obtained as: Fout=F2D−out⊙Fmask.

Secondly, according to the foreground region Fmask in the first viewpoint map, foreground portion of pixels corresponding to a second viewpoint map Fright (label) are obtained as: FGT=Fright⊙Fmask.

Finally, a similarity between them is calculated by a reconstruction loss L1 loss: £ L1=L1(Fout, FGT).

£ stands for dot product operation.

### V. About Application Methods

The depth map optimization model and viewpoint rendering model trained by training sample set can be used to realize many applications.

The method flow does not limit the application mode of the trained depth map optimization model and/or the trained viewpoint rendering model.

Three examples are given below for illustrative purposes.

### 1. Optimize a Depth Map

In an optional embodiment, a depth map is often obtained through a preset algorithm, such as a monocular estimation algorithm, but the accuracy is low.

In order to facilitate image processing using a more accurate depth map, for example, using the depth map to optimize rendering of a corresponding single viewpoint map to improve a clarity of a foreground region and a smoothness of a background region; or using the depth map to perform more detailed foreground segmentation, etc., the depth map optimization model trained based on the above method embodiments may be used.

As shown in FIG. 4, FIG. 4 is a flowchart of a depth map optimization method according to an embodiment of the present disclosure.

At S201, a target viewpoint map and a target depth map are acquired.

The target depth map may include depth information of each pixel in the target viewpoint map.

At S202, the target viewpoint map and the target depth map are input into a pre-trained depth map optimization model to obtain an optimized depth map output by the depth map optimization model,

The depth map optimization model can be trained based on the above method embodiments.

The target viewpoint map can be any viewpoint map. For ease of description, any viewpoint map targeted is referred to as a target viewpoint map.

A specific manner in which the target depth map is acquired is not limited in the embodiment, and in some examples, it may be determined by a monocular estimation algorithm according to the target viewpoint map.

In this embodiment, the depth map can be optimized by using a trained depth map optimization model by means of machine learning, and the accuracy of depth information in the depth map can be improved.

### 2. Generate a Three-Dimensional Image

In an optional embodiment, a three-dimensional image can be generated using a same image at different viewpoints, such as a left viewpoint map and a right viewpoint map.

Thus, for a single viewpoint map, the same image at different viewpoints can be generated for generating a three-dimensional image using a depth map optimization model and a viewpoint rendering model that have been trained based on the above method embodiments.

As shown in FIG. 5, FIG. 5 is a flowchart of a three-dimensional image generation method according to an embodiment of the present disclosure.

At S301, a target viewpoint map and a target depth map are acquired.

The target depth map may include depth information of each pixel in the target viewpoint map.

At S302, the target viewpoint map and the target depth map are input into a pre-trained depth map optimization model to obtain an optimized depth map output by the depth map optimization model.

At S303, the optimized depth map and the target viewpoint map are input into a pre-trained viewpoint rendering model to obtain a prediction viewpoint map output by the viewpoint rendering model.

The depth map optimization model and the viewpoint rendering model can be trained based on the above method embodiments.

At S304, the target viewpoint map and the prediction viewpoint map are interleaved to generate a three-dimensional image.

In this embodiment, the depth map can be optimized by using a trained depth map optimization model by means of machine learning, the accuracy of depth information in the depth map can be improved, a prediction viewpoint map at different viewpoints can be further generated by using a trained viewpoint rendering model, and a three-dimensional image can be generated by interleaving, so as to realize a generation of the three-dimensional image and improve the accuracy of the three-dimensional image.

The target viewpoint map can be any viewpoint map. For ease of description, any viewpoint map targeted is referred to as a target viewpoint map.

A specific manner in which the target depth map is acquired is not limited in the embodiment, and in some examples, it may be determined by a monocular estimation algorithm according to the target viewpoint map. Based on this method, a depth map to be optimized can be generated for a single viewpoint map, and then a three-dimensional image can be generated by using this embodiment.

A way of interleaving processing is not limited in the embodiment. Specifically, multi-viewpoint map interleaving processing can be used to generate a three-dimensional image.

### 3. Three-Dimensional Video Conversion

Based on a single-viewpoint image, a same image at another viewpoint can be predicted by the above method to generate a three-dimensional image, and therefore, the above method process can be further performed to generate a three-dimensional image for each video frame (i.e., the single viewpoint map) in the video separately to obtain a three-dimensional video.

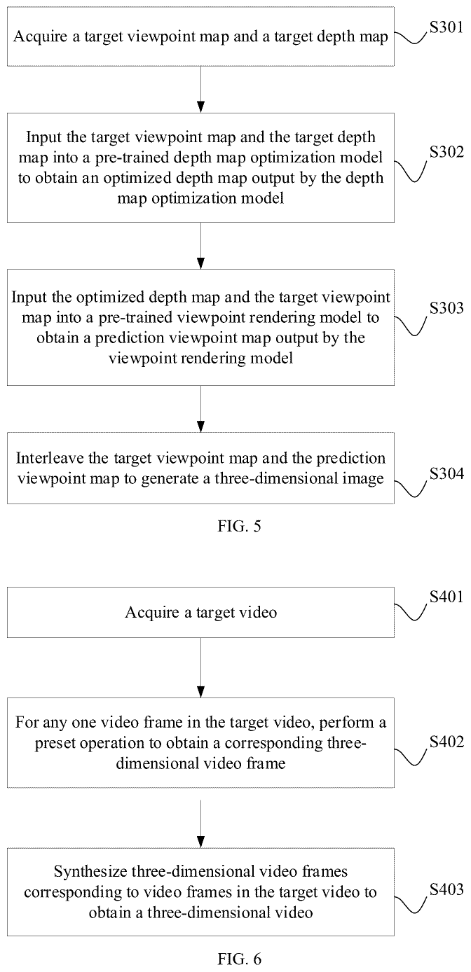

As shown in FIG. 6, FIG. 6 is a flowchart of a three-dimensional video conversion method according to an embodiment of the present disclosure.

At S401, a target video is acquired.

At S402, for any one video frame in the target video, a preset operation is performed to obtain a corresponding three-dimensional video frame.

The preset operation includes: acquiring a target depth map corresponding to the video frame, where the target depth map includes depth information of each pixel in the video frame; inputting the video frame and the target depth map into a pre-trained depth map optimization model to obtain an optimized depth map output by the depth map optimization model; inputting the optimized depth map and the video frame into a pre-trained viewpoint rendering model to obtain a prediction viewpoint map output by the viewpoint rendering model; where the depth map optimization model and the viewpoint rendering model can be obtained by training based on the above method embodiments; interleaving the video frame and the prediction viewpoint map to generate a corresponding three-dimensional video frame.

At S403, three-dimensional video frames corresponding to video frames in the target video are synthesized to obtain a three-dimensional video.

A manner in which the target video is acquired is not limited in the embodiment. It can be from local or a received target video.

The target video can be any video. For ease of description, any video targeted is referred to as a target video.

A way of synthesizing three-dimensional video frames is not limited in the embodiment. In some examples, corresponding three-dimensional video frames may be combined according to an order between video frames in the target video to obtain a three-dimensional video.

In some examples, a preset operation can be performed for each video frame in the target video to obtain the corresponding three-dimensional video frame. Specifically, the three-dimensional video may be obtained by synthesizing the three-dimensional video frames corresponding to each video frame in the target video.

In this embodiment, the depth map can be optimized by using a trained depth map optimization model by means of machine learning, the accuracy of depth information in the depth map can be improved, a prediction viewpoint map at different viewpoints can be further generated by using a trained viewpoint rendering model, and a three-dimensional image can be generated by interleaving, so as to realize a generation of the three-dimensional image and improve the accuracy of the three-dimensional image.

Based on the generation of three-dimensional images, a three-dimensional video can also be generated to improve the accuracy of three-dimensional video.

For ease of understanding, an embodiment of the present disclosure further provides an application embodiment.

### 1. Background

Along with a diversification of user needs and high standardization, ultra-high-definition 2D images are gradually difficult to meet a user's viewing needs, and three-dimensional sense and visual impact brought by 3D images have become a latest pursuit of users. Therefore, naked-eye 3D display technology has become a latest hot spot in the display field. At present, there are naked-eye 3D display screens, 3D photo albums, 3D tablets and other products. It is foreseeable that naked-eye 3D has become a new outlet in the display field.

With the arrival of naked-eye 3D display products, there is a wide demand for consumer-grade 3D content in the market.

There are two sources of 3D content:
1. Shoot native 3D images and videos directly with binocular cameras. However, binocular cameras are not popular, the cost is expensive, and the existing 2D content cannot be used, so it is necessary to re-shoot 3D content. Therefore, this solution is currently not suitable for the general needs of users.
2. Convert existing 2D images and videos to 3D. At present, most of this project is made by a large number of people using professional software for post-production, which is mostly used in film-level production. However, manual post-production is expensive, time-consuming and labor-intensive, and it is also not suitable for the general needs of users.

Currently, with the rise of deep learning, applying deep learning technology to 3D image generation has become one of the most advanced research directions in the display field. Compared with manual post-production, 3D image generation technology based on deep learning has the advantages of high efficiency, low cost and high generation quality, which is very suitable for a wide range of consumer demand.

In a process of 3D image generation, existing 2D images need to be used to generate corresponding depth maps, and then both of them are used as inputs in the process of 3D image generation.

However, an application target of the existing monocular depth estimation algorithm is not 3D image generation, so it is not suitable for 3D image generation.

Specifically, a depth map used for 3D image generation should be more accurate in a foreground region of an image, while a background region should be smoother.

However, the existing monocular depth estimation algorithm is insufficient in foreground accuracy estimation, which will cause the generated viewpoint image to have very significant artifacts subjectively.

Therefore, it is particularly necessary to study a depth map region optimization algorithm suitable for 3D image generation, so as to adapt to different quality depth maps as input and effectively improve the accuracy of depth estimation in foreground regions.

There is currently no open-source depth map dataset available for 3D image generation. This data set is difficult to obtain and expensive.

The solution proposed in this embodiment cleverly uses an unsupervised learning method, and can still effectively implement the training of the depth map optimization model without accurate depth maps for labeling.

### 2. Brief Introduction of the Solution

This embodiment designs a depth map region optimization algorithm based on unsupervised learning.

Aiming at the problem that the existing monocular depth estimation algorithm is not suitable for 3D image generation, and it is difficult to obtain a corresponding depth map of 3D image, according to this embodiment, a depth map optimization algorithm that can be trained without depth data set is innovatively designed, and a gradual fusion viewpoint rendering algorithm is proposed, which significantly improves the generation artifacts caused by inaccurate foreground depth and effectively improves the robustness of 3D image generation.

### 3. Explanation of Solution Steps

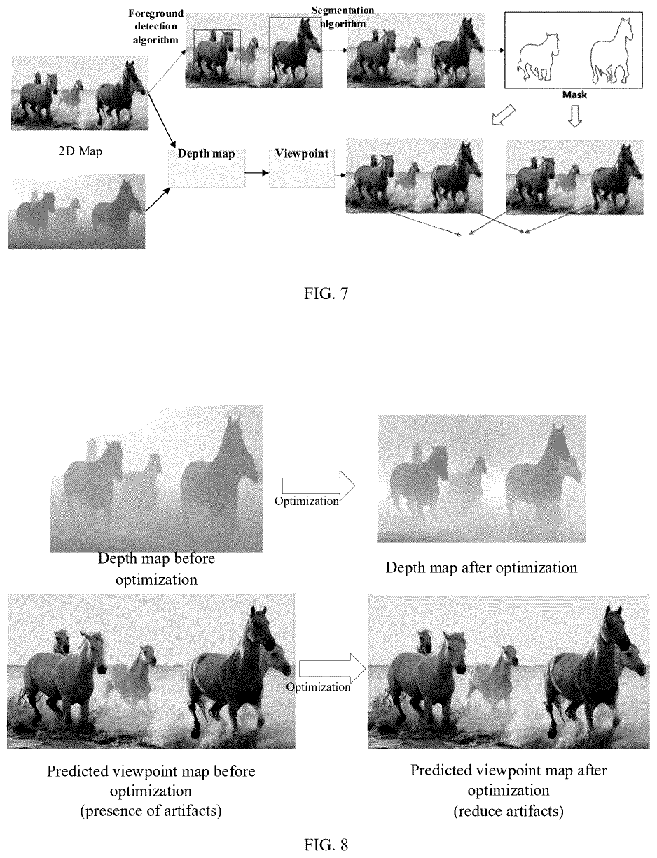

As shown in FIG. 7, FIG. 7 is a principle diagram of a depth map optimization model training according to an embodiment of the present disclosure.

The depth map optimization algorithm proposed in this embodiment is carried out on the premise of having a 3D data set and a trained viewpoint rendering model.

The 3D data set (such as an open source KITTY data set) includes a left viewpoint map Fleft, a right viewpoint map Fright and a depth map FDep corresponding to the left viewpoint map.

The functional requirement of the viewpoint rendering model used in this embodiment is to output a corresponding right viewpoint map according to an input left viewpoint map and a depth map.

The left viewpoint map is a 2D image in FIG. 7, and the right viewpoint map is an original viewpoint map in FIG. 7.

The method steps are as follows:
1. Firstly, a foreground region in the left viewpoint map Fleft is extracted by using a target detection algorithm (such as Fast R-CNN, YOLO v5, SSD, etc.).
2. Then, the foreground region is segmented by an instance segmentation algorithm (such as PP-Matting, Unet, etc.), and a Fmask (mask map corresponding to the left viewpoint map Fleft) is obtained.
3. Then, the left viewpoint map Fleft and its corresponding depth map FDep are input into a depth map optimization model to obtain an optimized depth map FDep-out.
4. Next, FDep-out and Fleft are input into a trained viewpoint rendering model (parameter freezing), and a new viewpoint map F2D-out is rendered according to FDep-out.
5. Finally, according to a preset mask map, a corresponding region in F2D-out is taken out, and a corresponding region in the right viewpoint map Fright (label) is also taken out, and a loss between the two regions is calculated and the gradient is updated, thus completing a training of the model once.

It should be noted that since the parameters of the viewpoint rendering model are frozen, training will only update the parameters of the depth map optimization model.

By skillfully using the existing viewpoint rendering model and 3D data set (which is configured to generate left and right viewpoint data sets), the loss is transformed from an unlabeled depth space to a labeled left and right viewpoint space, and an unsupervised learning-based depth map optimization algorithm is realized.

At the same time, since the total model is only fitted to the mask map (foreground region), there is no need to circle the foreground region in advance after training, and the model can automatically have the foreground selection capability.

The solution proposed in this embodiment has no special requirements for the viewpoint rendering algorithm and can be widely used in 3D image/video conversion services to further optimize the depth map obtained by the depth estimation algorithm.

Since a selection of available target detection and instance segmentation algorithm is relatively flexible, suitable target detection and segmentation algorithms can be selected accordingly based on actual business scenario requirements. For example, for 3D conversion of live broadcast scenes, a target detection and portrait cutout algorithms for portraits can be selected to obtain “hairline-level” 3D conversion for anchors.

For a more detailed explanation of the model structure, please refer to the above.

For ease of understanding, an example of image optimization is given below.

As shown in FIG. 8, FIG. 8 is a schematic diagram of an image optimization result according to an embodiment of the present disclosure.

It includes a depth map before optimization, a depth map after optimization, a right viewpoint map before optimization and a right viewpoint map after optimization.

Corresponding to the above method embodiments, the embodiments of the present disclosure provide corresponding apparatus embodiments.

As shown in FIG. 9, FIG. 9 is a schematic structural diagram of a depth map optimization model training apparatus according to an embodiment of the present disclosure.

The apparatus may include the following units.

The acquisition unit 501, configured to acquire a depth map optimization model and a viewpoint rendering model, and acquire a training sample set; where sample features of any one training sample in the training sample set includes a first viewpoint map and a first depth map, and a sample label of the any one training sample includes a second viewpoint map corresponding to the first viewpoint map;
the first depth map includes depth information of each pixel in the first viewpoint map, and the first viewpoint map and the second viewpoint map represent a same image at different viewpoints;
the depth map optimization model is configured to, according to an input first viewpoint map and an input first depth map, optimize the input first depth map to obtain an optimized depth map;
the viewpoint rendering model is configured to predict a corresponding second viewpoint map according to the input first viewpoint map and the optimized depth map obtained by the depth map optimization model to obtain a prediction viewpoint map;
a training unit 502, configured to train the depth map optimization model and the viewpoint rendering model based on the training sample set; and
during the training, update parameters of the depth map optimization model according to a loss between the second viewpoint map and the prediction viewpoint map.

In some examples, the training unit 502 is further configured to determine a foreground region for the first viewpoint map;
the training unit 502 is configured to:
update the parameters of the depth map optimization model according to a loss between the second viewpoint map and the prediction viewpoint map in a same target region;
where a position of the target region in the second viewpoint map and the prediction viewpoint map is the same as a position of the determined foreground region in the first viewpoint map.

In some examples, the training unit 502 is further configured to perform any of the following to determine the foreground region for the first viewpoint map:
perform foreground target detection on the first viewpoint map to determine the foreground region;
perform foreground target detection on the first viewpoint map to obtain a foreground region box, performing target segmentation on an image content in the foreground region box, and determining a segmented image content as the foreground region; or
perform foreground target segmentation on the first viewpoint map, and determine a segmented image content as a foreground region.

In some examples, the depth map optimization model includes a viewpoint map feature extraction layer and a depth map feature extraction layer;
where the viewpoint map feature extraction layer is configured to extract a first viewpoint feature map from the input first viewpoint map, and obtain a second viewpoint feature map by raising a dimensionality of the obtained first viewpoint feature map; and
the depth map feature extraction layer is configured to extract a first depth feature map from the input first depth map, and obtain a second depth feature map by raising a dimensionality of the obtained first depth feature map.

In some examples, the depth map optimization model includes a feature fusion layer;
where the depth map optimization model is configured to obtain a synthesized feature map by synthesizing a viewpoint feature map extracted from the first viewpoint map and a depth feature map extracted from the first depth map;
the feature fusion layer is configured to obtain a dimension-reduction feature map by reducing a dimensionality of an input feature map, obtain a fused feature map by performing feature fusion on the dimension-reduction feature map, obtain a dimension-raising feature map by raising a dimensionality of the fused feature map, and output a sum of the dimension-raising feature map and the input feature map;
the input feature map includes any one of: the synthesized feature map, a feature map extracted from the synthesized feature map, or a feature map output by other feature fusion layer.

In some examples, the first viewpoint map, the first viewpoint map, the first depth map and the second viewpoint map are acquired based on a same three-dimensional image.

In some examples, any one training sample in the training sample set is acquired by:
acquiring a target three-dimensional image;
acquiring images of the target three-dimensional image at two different viewpoints, and taking the images respectively as the first viewpoint map and the second viewpoint map corresponding to the first viewpoint map;
determining the first depth map by acquiring the depth information of each pixel in the first viewpoint map based on depth information of the target three-dimensional image; or, determining the first depth map from the first viewpoint map with a preset depth estimation algorithm; and
obtaining a training sample by taking the determined first viewpoint map and the determined first depth map as the sample features and taking the determined second viewpoint map as the sample label.

In some examples, the viewpoint rendering model is pre-trained; and the training unit 502 is further configured to freeze parameters of the viewpoint rendering model while training the depth map optimization model and the viewpoint rendering model.

In some examples, the training unit 502 is further configured to:
during the training, update parameters of the viewpoint rendering model based on the loss between the second viewpoint map and the prediction viewpoint map.

In some examples, the viewpoint rendering model includes a first dimension-raising fusion layer;
the viewpoint rendering model is configured to extract a third viewpoint feature map with a first size and a fourth viewpoint feature map with a second size from the first viewpoint map, where the first size is smaller than the second size, and obtain an optimized fusion feature map with the first size by performing feature fusion on the third viewpoint feature map and an optimized feature map extracted from the optimized depth map; and
the first dimension-raising fusion layer is configured to obtain a dimension-raising fusion feature map with the second size by raising a dimensionality of the optimized fusion feature map, perform feature fusion on the dimension-raising fusion feature map and the fourth viewpoint feature map, and output a fusion result of the second size.

In some examples, the viewpoint rendering model further includes a second dimension-raising fusion layer;
the viewpoint rendering model is further used to extract a fifth viewpoint feature map with a third size from the first viewpoint map; where the second size is smaller than the third size; and the second dimension-raising fusion layer is configured to obtain a to-be-fused feature map with the third size by raising a dimensionality of the fusion result output by the first dimension-raising fusion layer, perform feature fusion on the to-be-fused feature map and the fifth viewpoint feature map, and output a fusion result of the third size.

For a detailed explanation, please refer to the above method embodiments.

As shown in FIG. 10, FIG. 10 is a schematic structural diagram of a depth map optimization apparatus according to an embodiment of the present disclosure.

The apparatus may include the following units.

A first map acquisition unit 601, configured to acquire a target viewpoint map and a target depth map, where the target depth map includes depth information of each pixel in the target viewpoint map.

A first optimization unit 602, configured to input the target viewpoint map and the target depth map into a pre-trained depth map optimization model to obtain an optimized depth map output by the depth map optimization model.

The depth map optimization model is trained by the above training apparatus or the above method embodiments.

For a detailed explanation, please refer to the above method embodiments.

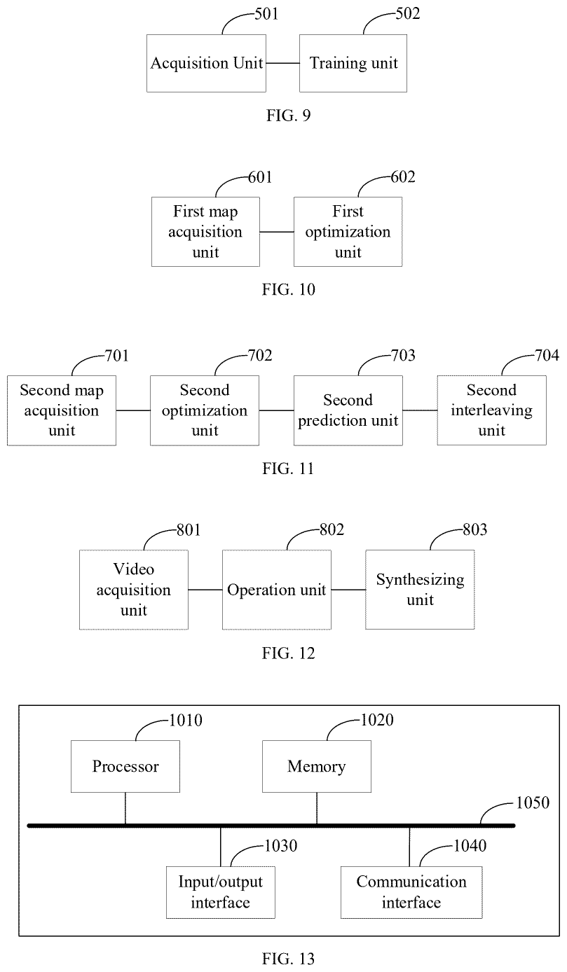

As shown in FIG. 11, FIG. 11 is a schematic structural diagram of a three-dimensional image generation apparatus according to an embodiment of the present disclosure.

The apparatus may include the following units.

A second map acquisition unit 701, configured to acquire a target viewpoint map and a target depth map, where the target depth map includes depth information of each pixel in the target viewpoint map.

A second optimization unit 702, configured to input the target viewpoint map and the target depth map into a pre-trained depth map optimization model to obtain an optimized depth map output by the depth map optimization model.

A second prediction unit 703, configured to input the optimized depth map and the target viewpoint map into a pre-trained viewpoint rendering model to obtain a prediction viewpoint map output by the viewpoint rendering model.

The depth map optimization model and the viewpoint rendering model are trained by the training apparatus or the above method embodiments.

A second interleaving unit 704, configured to interleave the target viewpoint map and the prediction viewpoint map to generate a three-dimensional image.

For a detailed explanation, please refer to the above method embodiments.

As shown in FIG. 12, FIG. 12 is a schematic structural diagram of a three-dimensional video conversion apparatus according to an embodiment of the present disclosure.

The apparatus may include the following units.

A video acquisition unit 801, configured to acquire a target video.

An operation unit 802, configured to, for any one video frame in the target video, perform following operations to obtain a corresponding three-dimensional video frame: acquire a target depth map corresponding to the video frame, where the target depth map includes depth information of each pixel in the video frame; input the video frame and the target depth map into a pre-trained depth map optimization model to obtain an optimized depth map output by the depth map optimization model; input the optimized depth map and the video frame into a pre-trained viewpoint rendering model to obtain a prediction viewpoint map output by the viewpoint rendering model; where the depth map optimization model and the viewpoint rendering model are trained by the above training apparatus or the above method embodiments; and interleave the video frame and the prediction viewpoint map to generate a corresponding three-dimensional video frame.

A synthesizing unit 803, configured to synthesize three-dimensional video frames corresponding to video frames in the target video to obtain a three-dimensional video.

For a detailed explanation, please refer to the above method embodiments.

An embodiment of the present disclosure further provides a computer device, which at least includes a memory, a processor, and a computer program stored on the memory and executable on the processor, where the processor implements any of the above method embodiments when executing the program.

An embodiment of the present disclosure further provides an electronic device, which includes at least one processor; and a memory communicatively connected with the at least one processor; where, the memory stores instructions executable by the at least one processor, and the instructions are executed by the at least one processor to enable the at least one processor to perform any of the above method embodiments.

FIG. 13 is a schematic diagram of a hardware structure of a computer device for configuring the method according to an embodiment of the present disclosure. The device may include a processor 1010, a memory 1020, an input/output interface 1030, a communication interface 1040 and a bus 1050. The processor 1010, the memory 1020, the input/output interface 1030 and the communication interface 1040 communicate with each other through the bus 1050.

The processor 1010 can be realized by a general central processing unit (CPU), a microprocessor, an application specific integrated circuit (ASIC), or one or more integrated circuits, etc., and is used for executing related programs to realize the technical solutions provided by the embodiments of the present disclosure.

The memory 1020 can be implemented in the form of read only memory (ROM), random access memory (RAM), static storage device, dynamic storage device, etc. The memory 1020 can store an operating system and other application programs. When the technical solutions provided by the embodiments of the present disclosure is realized by software or firmware, the relevant program codes are stored in the memory 1020 and called by the processor 1010 for execution.

The input/output interface 1030 is configured to connect input/output modules to realize information input and output. An input/output/module can be configured in a device as a component (not shown in the figure), or can be externally connected to the device to provide corresponding functions. The input device may include a keyboard, a mouse, a touch screen, a microphone, various types of sensors, etc., and the output device may include a display, a speaker, a vibrator, an indicator light, etc.

The communication interface 1040 is configured to connect a communication module (not shown in the figure) to realize communication interaction between the device and other devices. The communication module can realize communication by wired means (such as USB, network cable, etc.) or wireless means (such as mobile network, WIFI, Bluetooth, etc.).

The bus 1050 includes a path to transfer information between various components of the device, such as the processor 1010, the memory 1020, the input/output interface 1030 and the communication interface 1040.

It should be noted that although the above device only shows the processor 1010, the memory 1020, the input/output interface 1030, the communication interface 1040 and the bus 1050, in a specific implementation process, the device may further include other components necessary for normal operation. In addition, those skilled in the art can understand that the device may also include only components necessary to implement the embodiments of the present disclosure, and does not necessarily include all the components shown in the figure.

An embodiment of the present disclosure further provides a computer-readable storage medium, on which a computer program is stored, which, when executed by a processor, realizes any of the above method embodiments.

An embodiment of the present disclosure further provides a computer-readable storage medium storing a computer program which, when executed by a processor, realizes any of the above method embodiments.

The computer-readable media, including permanent and non-permanent, removable and non-removable media, can store information by any method or technology. Information can be computer-readable instructions, data structures, modules of programs or other data. Examples of storage media for a computer include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disc read-only memory (CD-ROM), digital versatile disks (DVD) or other optical storage, magnetic cassettes, disk storage or other magnetic storage devices, or any other non-transmission medium that can be used to store information that can be accessed by a computing device. As defined herein, the computer-readable medium does not include transitory media, such as modulated data signals and carrier waves.

It can be seen from the description of the above embodiments that those skilled in the art can clearly understand that the embodiments of the present disclosure can be implemented by means of software plus a necessary universal hardware platform. Based on such understanding, the technical solutions of the embodiments of the present disclosure essentially or the part contributing to the prior art may be embodied in the form of a software product, and the computer software product may be stored in a storage medium, such as a ROM/RAM, a magnetic disk, an optical disk, and the like, and includes several instructions for enabling a computer device (which may be a personal computer, a server, or a network device, etc.) to execute the method described in each embodiment or some parts of the embodiments of the present disclosure.

The systems, apparatuses, modules or units illustrated in the above embodiments may specifically be realized by a computer chip or an entity, or by a product with a certain function. A typical implementation device is a computer, and a specific form of the computer may be a personal computer, a laptop computer, a cellular telephone, a camera phone, a smart phone, a personal digital assistant, a media player, a navigation device, an e-mail transceiver, a gaming console, a tablet computer, a wearable device, or a combination of any of these devices.

The embodiments in this specification are described in a progressive manner, the same and similar parts between the embodiments may refer to each other, and each embodiment focuses on differences from other embodiments. In particular, for the apparatus embodiments, since they are substantially similar to the method embodiments, the description is relatively simple, and reference may be made to some descriptions of the method embodiments for related parts. The apparatus embodiments described above are merely illustrative, the modules described as separate components may or may not be physically separate, and functions of the modules may be implemented in one or more pieces of software and/or hardware when implementing the solutions in the embodiments of the present disclosure. Some or all of the modules may also be selected according to actual needs to achieve the objective of the solutions of the embodiments. It can be understood and implemented by a person of ordinary skill in the art without creative labor.

The above description is only a specific implementation of the embodiments of the present disclosure, and it should be noted that those skilled in the art can make several improvements and modifications without departing from the principle of the embodiments of the present disclosure, and these improvements and modifications should also be regarded as the protection of the embodiments of the present disclosure.

In the present disclosure, the terms “first” and “second” are only used for descriptive purposes and cannot be understood as indicating or implying relative importance. The term “plurality” refers to two or more, unless otherwise explicitly defined.

Other embodiments of the present disclosure will easily occur to those skilled in the art after considering the specification and practicing the present disclosure disclosed herein. The present disclosure is intended to cover any variations, uses or adaptations of the present disclosure, and these variations, uses or adaptations follow general principles of the present disclosure and include common sense or common technical means in the technical field that are not disclosed in the present disclosure. The specification and embodiments are to be regarded as exemplary only, and true scope and spirit of the present disclosure are indicated by the following claims.

It should be understood that the present disclosure is not limited to precise structures described above and shown in the accompanying drawings, and various modifications and changes can be made without departing from its scope. The scope of the present disclosure is limited only by the appended claims.

1. A depth map optimization model training method, comprising:
acquiring a depth map optimization model and a viewpoint rendering model;
acquiring a training sample set;
wherein sample features of any one training sample in the training sample set comprises a first viewpoint map and a first depth map, and a sample label of the any one training sample comprises a second viewpoint map corresponding to the first viewpoint map;
the first depth map comprises depth information of each pixel in the first viewpoint map, and the first viewpoint map and the second viewpoint map represent a same image at different viewpoints;
the depth map optimization model is configured to, according to an input first viewpoint map and an input first depth map, optimize the input first depth map to obtain an optimized depth map;
the viewpoint rendering model is configured to predict a corresponding second viewpoint map according to the input first viewpoint map and the optimized depth map obtained by the depth map optimization model to obtain a prediction viewpoint map;
training the depth map optimization model and the viewpoint rendering model based on the training sample set; and
during the training, updating parameters of the depth map optimization model according to a loss between the second viewpoint map and the prediction viewpoint map.

2. The method according to claim 1, further comprising: determining a foreground region for the first viewpoint map;
wherein updating the parameters of the depth map optimization model according to the loss between the second viewpoint map and the prediction viewpoint map comprises:
updating the parameters of the depth map optimization model according to a loss between the second viewpoint map and the prediction viewpoint map in a same target region;
wherein a position of the target region in the second viewpoint map and the prediction viewpoint map is the same as a position of the determined foreground region in the first viewpoint map.

3. The method according to claim 2, wherein determining the foreground region for the first viewpoint map comprises a step selected from a group consisting of:
performing foreground target detection on the first viewpoint map to determine the foreground region;
performing foreground target detection on the first viewpoint map to obtain a foreground region box, performing target segmentation on an image content in the foreground region box, and determining a segmented image content comprising a target as the foreground region;
performing foreground target segmentation on the first viewpoint map, and determining a segmented image content comprising a target as the foreground region; and
any combination thereof.

4. The method according to claim 1, wherein the depth map optimization model comprises a viewpoint map feature extraction layer and a depth map feature extraction layer;
wherein the viewpoint map feature extraction layer is configured to extract a first viewpoint feature map from the input first viewpoint map, and obtain a second viewpoint feature map by raising a dimensionality of the obtained first viewpoint feature map; and
the depth map feature extraction layer is configured to extract a first depth feature map from the input first depth map, and obtain a second depth feature map by raising a dimensionality of the obtained first depth feature map.

5. The method according to claim 1, wherein the depth map optimization model comprises a feature fusion layer;
wherein the depth map optimization model is configured to obtain a synthesized feature map by synthesizing a viewpoint feature map extracted from the first viewpoint map and a depth feature map extracted from the first depth map;
the feature fusion layer is configured to obtain a dimension-reduction feature map by reducing a dimensionality of an input feature map, obtain a fused feature map by performing feature fusion on the dimension-reduction feature map, obtain a dimension-raising feature map by raising a dimensionality of the fused feature map, and output a sum of the dimension-raising feature map and the input feature map;
the input feature map comprises a map selected from a group consisting of: the synthesized feature map, a feature map extracted from the synthesized feature map, a feature map output by other feature fusion layer; and any combination thereof.

6. The method according to claim 1, further comprising: acquiring the first viewpoint map, the first depth map and the second viewpoint map based on a same three-dimensional image.

7. The method according to claim 1, wherein acquiring any one training sample in the training sample set comprises:
acquiring a target three-dimensional image;
acquiring images of the target three-dimensional image at two different viewpoints, and taking the images respectively as the first viewpoint map and the second viewpoint map corresponding to the first viewpoint map;
determining the first depth map by acquiring the depth information of each pixel in the first viewpoint map based on depth information of the target three-dimensional image; and
obtaining a training sample by taking the determined first viewpoint map and the determined first depth map as the sample features and taking the determined second viewpoint map as the sample label.

8. The method according to claim 1, wherein the viewpoint rendering model is pre-trained; the method further comprises: freezing parameters of the viewpoint rendering model while training the depth map optimization model and the viewpoint rendering model.

9. The method according to claim 1, further comprising:
during the training, updating parameters of the viewpoint rendering model based on the loss between the second viewpoint map and the prediction viewpoint map.

10. The method according to claim 1, wherein the viewpoint rendering model comprises a first dimension-raising fusion layer;
the viewpoint rendering model is configured to extract a third viewpoint feature map with a first size and a fourth viewpoint feature map with a second size from the first viewpoint map, wherein the first size is smaller than the second size, and obtain an optimized fusion feature map with the first size by performing feature fusion on the third viewpoint feature map and an optimized feature map extracted from the optimized depth map; and
the first dimension-raising fusion layer is configured to obtain a dimension-raising fusion feature map with the second size by raising a dimensionality of the optimized fusion feature map, perform feature fusion on the dimension-raising fusion feature map and the fourth viewpoint feature map, and output a fusion result of the second size.

11. The method according to claim 10, wherein the viewpoint rendering model further comprises a second dimension-raising fusion layer;
the viewpoint rendering model is configured to extract a fifth viewpoint feature map with a third size from the first viewpoint map; wherein the second size is smaller than the third size; and
the second dimension-raising fusion layer is configured to obtain a to-be-fused feature map with the third size by raising a dimensionality of the fusion result output by the first dimension-raising fusion layer, perform feature fusion on the to-be-fused feature map and the fifth viewpoint feature map, and output a fusion result of the third size.

12. A depth map optimization method, comprising:
acquiring a target viewpoint map and a target depth map, wherein the target depth map comprises depth information of each pixel in the target viewpoint map; and
inputting the target viewpoint map and the target depth map into a pre-trained depth map optimization model to obtain an optimized depth map output by the depth map optimization model;
wherein the depth map optimization model is trained based on the training method according to claim 1.

13. A three-dimensional image generation method, comprising:
acquiring a target viewpoint map and a target depth map, wherein the target depth map comprises depth information of each pixel in the target viewpoint map; and
inputting the target viewpoint map and the target depth map into a pre-trained depth map optimization model to obtain an optimized depth map output by the depth map optimization model;
inputting the optimized depth map and the target viewpoint map into a pre-trained viewpoint rendering model to obtain a prediction viewpoint map output by the viewpoint rendering model;
wherein the depth map optimization model and the viewpoint rendering model are trained based on the training method according to claim 1;
interleaving the target viewpoint map and the prediction viewpoint map to generate a three-dimensional image.

14. A three-dimensional video conversion method, comprising:
acquiring a target video;
for any one video frame in the target video, obtaining a corresponding three-dimensional video frame by performing:
acquiring a target depth map corresponding to the video frame, wherein the target depth map comprises depth information of each pixel in the video frame;
inputting the video frame and the target depth map into a pre-trained depth map optimization model to obtain an optimized depth map output by the depth map optimization model;
inputting the optimized depth map and the video frame into a pre-trained viewpoint rendering model to obtain a prediction viewpoint map output by the viewpoint rendering model;
wherein the depth map optimization model and the viewpoint rendering model are trained based on the training method according to claim 1;
interleaving the video frame and the prediction viewpoint map to generate a corresponding three-dimensional video frame; and
synthesizing three-dimensional video frames corresponding to video frames in the target video to obtain a three-dimensional video.

15. A depth map optimization model training apparatus, comprising:
at least one processor; and,
a memory communicatively connected to the at least one processor; wherein,
the memory stores instructions executable by the at least one processor, and the instructions are executed by the at least one processor, the at least one processor is configured to:
acquire a depth map optimization model and a viewpoint rendering model, and acquire a training sample set; wherein sample features of any one training sample in the training sample set comprises: a first viewpoint map and a first depth map, and a sample label of the any one training sample comprises: a second viewpoint map corresponding to the first viewpoint map;
the first depth map comprises depth information of each pixel in the first viewpoint map, and the first viewpoint map and the second viewpoint map represent a same image at different viewpoints;
the depth map optimization model is configured to, according to an input first viewpoint map and an input first depth map, optimize the input first depth map to obtain an optimized depth map;
the viewpoint rendering model is configured to predict a corresponding second viewpoint map according to the input first viewpoint map and the optimized depth map obtained by the depth map optimization model to obtain a prediction viewpoint map; and
train the depth map optimization model and the viewpoint rendering model based on the training sample set; and during the training, update parameters of the depth map optimization model according to a loss between the second viewpoint map and the prediction viewpoint map.

16. A depth map optimization apparatus, comprising:
at least one processor; and,
a memory communicatively connected to the at least one processor; wherein,
the memory stores instructions executable by the at least one processor, and the instructions are executed by the at least one processor, the at least one processor is configured to:
acquire a target viewpoint map and a target depth map, wherein the target depth map comprises depth information of each pixel in the target viewpoint map; and
input the target viewpoint map and the target depth map into a pre-trained depth map optimization model to obtain an optimized depth map output by the depth map optimization model;
wherein the depth map optimization model is trained based on the training apparatus according to claim 15.

17. A three-dimensional image generation apparatus, comprising:
at least one processor; and,
a memory communicatively connected to the at least one processor; wherein,
the memory stores instructions executable by the at least one processor, and the instructions are executed by the at least one processor, the at least one processor is configured to:
acquire a target viewpoint map and a target depth map, wherein the target depth map comprises depth information of each pixel in the target viewpoint map;
input the target viewpoint map and the target depth map into a pre-trained depth map optimization model to obtain an optimized depth map output by the depth map optimization model;
input the optimized depth map and the target viewpoint map into a pre-trained viewpoint rendering model to obtain a prediction viewpoint map output by the viewpoint rendering model;
wherein the depth map optimization model and the viewpoint rendering model are trained based on the training apparatus according to claim 15; and
interleave the target viewpoint map and the prediction viewpoint map to generate a three-dimensional image.

18. A three-dimensional video conversion apparatus, comprising:
at least one processor; and,
a memory communicatively connected to the at least one processor; wherein,
the memory stores instructions executable by the at least one processor, and the instructions are executed by the at least one processor, the at least one processor is configured to:
acquire a target video;
for any one video frame in the target video, perform following operations to obtain a corresponding three-dimensional video frame:
acquire a target depth map corresponding to the video frame, wherein the target depth map comprises depth information of each pixel in the video frame;
input the video frame and the target depth map into a pre-trained depth map optimization model to obtain an optimized depth map output by the depth map optimization model;
input the optimized depth map and the video frame into a pre-trained viewpoint rendering model to obtain a prediction viewpoint map output by the viewpoint rendering model;
wherein the depth map optimization model and the viewpoint rendering model are trained based on the training apparatus according to claim 15;
interleave the video frame and the prediction viewpoint map to generate a corresponding three-dimensional video frame; and
synthesize three-dimensional video frames corresponding to video frames in the target video to obtain a three-dimensional video.

19. (canceled)

20. A non-transitory computer-readable storage medium storing a computer program, wherein the computer program, when executed by a processor, implements the method according to claim 1.

21. The method according to claim 1, wherein acquiring any one training sample in the training sample set comprises:
acquiring a target three-dimensional image;
acquiring images of the target three-dimensional image at two different viewpoints, and taking the images respectively as the first viewpoint map and the second viewpoint map corresponding to the first viewpoint map;
determining the first depth map from the first viewpoint map with a preset depth estimation algorithm; and
obtaining a training sample by taking the determined first viewpoint map and the determined first depth map as the sample features and taking the determined second viewpoint map as the sample label.
